(19) United States
(12) Patent Application Publication
(10) Pub. No.: US 2016/0088001 A1
(43) Pub. Date: Mar. 24, 2016

(54) COLLABORATIVE DEEP PACKET INSPECTION SYSTEMS AND METHODS

(71) Applicant: Alcatel-Lucent USA Inc., Murray Hill, NJ (US)

(72) Inventors: Chiang Yeh, Sierra Madre, CA (US); Jeremy W. Touve, Woodland Hills, CA (US); L. Michele Goodwin, Westlake Village, CA (US); Eric W. Tolliver, Moorpark, CA (US)

(73) Assignee: ALCATEL-LUCENT USA INC., Murray Hill, NJ (US)

(21) Appl. No.: 14/492,673

(22) Filed: Sep. 22, 2014

(51) Int. Cl. H04L 29/06; H04L 12/26

(52) U.S. Cl. CPC H04L 63/1416; H04L 43/0876

(57) ABSTRACT

A system for collaborative deep packet inspection in a network uses a coarse grain mechanism to perform deep packet inspection on sample packets sampled from a plurality of traffic flows received at a network device using a plurality of signatures and develop a profile of the network and a fine grain mechanism to perform real-time inspection of a traffic flow against a small set of the signatures that is updated based on the profile. The fine grain mechanism further enables at least one policy action to be applied to a traffic flow when the traffic flow matches one of the signatures in the set of signatures.

### BACKGROUND OF THE INVENTION

1. Technical Field of the Invention

This invention relates generally to network security and in particular to deep packet inspection in communications networks.

2. Description of Related Art

Network security is an important part of any network infrastructure. Network administrators adopt policies and implement various measures to prevent unauthorized access and protect networks against attackers who send spam, release worms or perform other illegal actions using the network. The most common way to secure a network is to allow access only from known, authenticated users using an authentication process, e.g., user name and password. However, this approach provides no security against “sniffing” and attackers can easily spoof legitimate network addresses. In addition, authentication procedures do not check the content of messages, and therefore, provide no protection against potentially harmful content, such as computer worms being transmitted over the network.

Deep packet inspection (DPI) is a highly useful technique to perform network intrusion detection and prevention, manage network-born threats, and augment the effectiveness of conventional firewalls. Deep packet inspection mechanisms are typically implemented in either hardware or software. In software inspection systems, network traffic is redirected, mirrored, or sampled to a computer or computing cluster that runs a deep packet inspection algorithm in software. In hardware inspection systems, network traffic is redirected, mirrored, or sampled to dedicated networking equipment equipped with a hardware inspection engine, typically using Ternary Content Addressable Memory (TCAM) or network processors highly optimized for the inspection algorithm. Alternatively, a networking switch/router can integrate the DPI functionality as part of its data path.

Unfortunately, DPI requires significant computing resources, i.e., microprocessor cycles, memory, non-volatile storage, etc., in order to achieve adequate performance. These steep requirements confine the application of DPI to only a limited throughput, and mandate expensive, bulky hardware in operation.

For example, in software inspection systems, since the algorithm is computationally and memory intensive, the computers or computer clusters are typically very powerful, utilizing multiple server class microprocessors, with a large on-chip cache, a large capacity hard disk and a large amount of DRAM. In addition, it is difficult to redirect a sufficient amount of traffic to the computer due to the limited I/O capacity of typical computer hardware. Furthermore, since the computer operates in a look-aside mode by necessity, the latency produced in such a configuration prohibits it from taking immediate action against a detected pattern on the network level, unless the same computer is also responsible for the firewall and access control list (ACL).

Dedicated networking equipment may provide better performance than software inspection systems, but at the expense of expandability and flexibility. The cost is also significantly higher in hardware inspection systems than in software inspection systems due to the required dedicated, expensive hardware (TCAM, network processors, etc.) as well as the research and development to design, maintain, and upgrade such equipment. In addition, changes in the inspection algorithm can render the dedicated hardware equipment obsolete. Furthermore, the DPI functionality cannot be virtualized using dedicated equipment. Therefore, integrated DPI functionality, by necessity, would be limited to either a small amount of traffic and/or a small number of signatures, due to the cost and power requirements of the accompanying circuitry.

These inherent cost and size limitations prevent integrating DPI features within networking equipment, such as switches and routers. However, since networking equipment is closest in proximity to the source of a potential threat and is therefore able to limit the proliferation of such threats most effectively through the application of DPI, it is desirable to implement DPI technology into such networking equipment.

At the same time, DPI is most effective when a large number of signatures are examined against the traffic. However, the cost of implementing DPI for a fixed amount of traffic is roughly exponential to the number of signatures against which the mechanism would examine, for both microprocessor cycles as well as memory. The asymptotic best case is O(n*log(n)) and the worst case is O(n̂2).) This fact makes implementing DPI on networking equipment prohibitively expensive.

### SUMMARY

Embodiments of the present disclosure are directed to collaborative deep packet inspection that combines elements of both hardware and software inspection systems. A network device includes at least one port coupled to a network to receive a plurality of traffic flows, each including a plurality of packets, a memory maintaining a set of signatures including less than all of a plurality of signatures and a processor for receiving sample packets sampled from the plurality of traffic flows and performing deep packet inspection on the sample packets against a plurality of signatures to develop a profile indicating network activity within the network. The processor further enables the set of signatures to be updated based on the profile. The network device further includes a signature matching engine for receiving a traffic flow and inspecting the traffic flow in real-time by comparing the traffic flow with each signature in the set of signatures to determine whether the traffic flow matches one of the signatures in the set of signatures. The signature matching engine further enables at least one policy action to be applied to the traffic flow when the traffic flow matches one of the signatures in the set of signatures.

In another embodiment, a system for collaborative deep packet inspection in a network includes a control server and a network device. The network device includes at least one port coupled to the network to receive a plurality of traffic flows, each including a plurality of packets, a memory maintaining a set of signatures including less than all of a plurality of signatures and a processor for receiving sample packets sampled from the plurality of traffic flows and performing deep packet inspection on the sample packets against a plurality of signatures to develop a profile indicating network activity within the network. The network device further includes a signature matching engine for receiving a traffic flow of the plurality of traffic flows and inspecting the traffic flow in real-time by comparing the traffic flow with each signature in the set of signatures to determine whether the traffic flow matches one of the signatures in the set of signatures. The signature matching engine further enables at least one policy action to be applied to the traffic flow when the traffic flow matches one of the signatures in the set of signatures. The control server is coupled to the network to receive the profile from the network device and update the set of signatures in the network device based on the profile.

In still another embodiment, a method for collaborative deep packet inspection in a network device includes maintaining a set of signatures including less than all of a plurality of signatures, receiving a plurality of traffic flows, each including a plurality of packets, sampling sample packets from the plurality of traffic flows, performing deep packet inspection on the sample packets against a plurality of signatures to develop a profile indicating network activity within the network and updating the set of signatures based on the profile. The method further includes inspecting a traffic flow of the plurality of traffic flows in real-time by comparing the traffic flow with each signature in the set of signatures, determining whether the traffic flow matches one of the signatures in the set of signatures and applying at least one policy action to the traffic flow when the traffic flow matches one of the signatures in the set of signatures.

In some embodiments of any of the above apparatus/methods, the profile includes at least one of applications running on the network and usage patterns in the network.

In some embodiments of any of the above apparatus/methods, the set of signatures is updated by at least one of adding one or more signatures from the plurality of signatures to the set of signatures and removing one or more signatures from the set of signatures.

In some embodiments of any of the above apparatus/methods, the sample packets are sampled randomly from the plurality of packets and include less than all of the plurality of packets.

In some embodiments of any of the above apparatus/methods, the sample packets are copies of select ones of the plurality of packets.

In some embodiments of any of the above apparatus/methods, the network device further includes a first platform including the processor, a second platform including the signature matching engine and the memory and an internal interface between the first platform and the second platform. The sampled packets are forwarded to the processor via the internal interface.

In some embodiments of any of the above apparatus/methods, the network device further includes a microprocessor on the second platform coupled to the signature matching engine to enforce the at least one policy action to be applied to the traffic flow.

In some embodiments of any of the above apparatus/methods, the signature matching engine further determines flow identification information identifying the traffic flow, determines an identification tag of a matching signature in the set of signatures that matches the traffic flow, determines a list of policy actions including the at least one policy action recommended for the matching signature and sends the identification tag, the flow identification information and the list of policy actions to the microprocessor.

In some embodiments of any of the above apparatus/methods, the microprocessor selects the at least one policy action from the list of policy actions to be applied to the traffic flow.

In some embodiments of any of the above apparatus/methods, the network device further includes a policy action table maintained by the microprocessor. The microprocessor updates the policy action table with the flow identification information and the at least one policy action.

In some embodiments of any of the above apparatus/methods, the flow identification information includes at least a source Internet Protocol (IP) address, a destination IP address, a source port number and a destination port number.

In some embodiments of any of the above apparatus/methods, the at least one policy action includes one or more of redirecting packets in the traffic flow, marking packets in the traffic flow, blocking packets in the traffic flow and reporting the traffic flow to a reporting device within the network.

In some embodiments of any of the above apparatus/methods, the set of signatures includes approximately 100 signatures.

In some embodiments of any of the above apparatus/methods, the network device is a switch or a router in the network.

In some embodiments of any of the above apparatus/methods, deep packet inspection and updating the set of signatures are performed in parallel to inspecting the traffic flow and applying the at least one policy action.

### BRIEF DESCRIPTION OF THE SEVERAL VIEWS OF THE DRAWINGS

FIG. 1 illustrates a schematic block diagram of an exemplary embodiment of a system for collaborative deep packet inspection;

FIG. 2 illustrates a schematic block diagram of another exemplary embodiment of a system for collaborative deep packet inspection;

FIG. 3 illustrates an exemplary table maintaining policy actions and traffic flows;

FIG. 4 illustrates an exemplary flow diagram of a method for real-time inspection of a traffic flow;

FIG. 5A illustrates an exemplary flow diagram of a method for performing deep packet inspection on sample packets;

FIG. 5B illustrates an exemplary flow diagram of a method for updating a set of signatures used for real-time inspection of a traffic flow; and

FIG. 6 illustrates an exemplary flow diagram of a method for collaborative deep packet inspection.

### DETAILED DESCRIPTION OF THE INVENTION

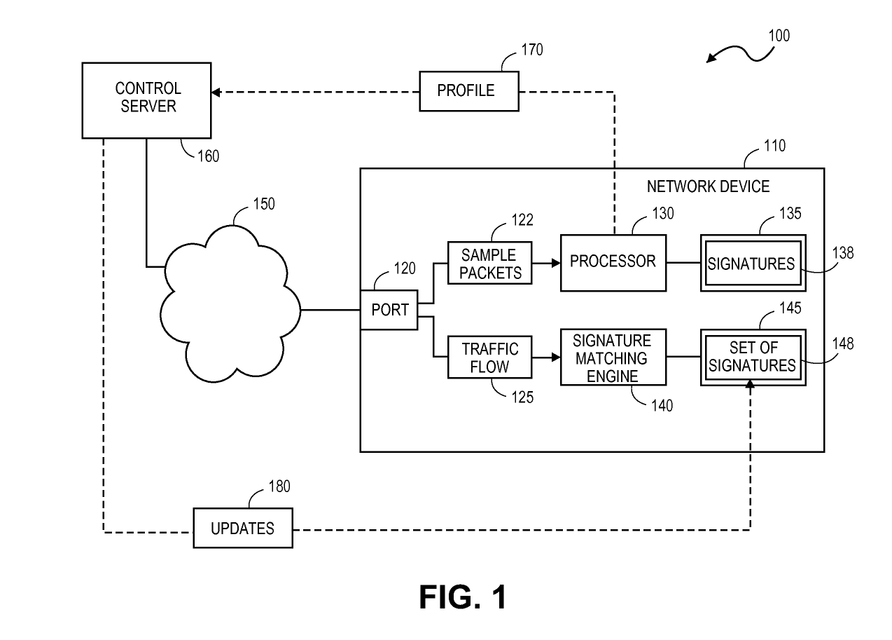

FIG. 1 illustrates a schematic block diagram of an exemplary embodiment of a system 100 for performing collaborative deep packet inspection. The system 100 includes a network device 110 and a control server 160, each coupled to a communication network 150. As used herein, the term “network device” refers to a hardware device within the communication network that connects together at least two different, remote components of the communication network. For example, in one embodiment, the network device 110 is a switch or a router. In other embodiments, the network device may be a gateway, network bridge, hub, repeater, Private Branch Exchange (PBX) or other type of networking equipment.

The control server 160 may be implemented within the network device 110 or may be external to the network device 110, as shown in FIG. 1. For example, the control server 160 may be a network management station within the communication network 150. As used herein, the term “control server” refers to a component in the communication network including a processor operable to execute a software algorithm to perform the functions of the control server. The communication network 150 may include, for example, one or more of a wired network (e.g., an Internet Protocol (IP) network, Ethernet local area network or other type of wired network) and a wireless network (e.g., WiFi, WLAN, 3G, 4G, LTE or other type of wireless network).

The network device 110 includes port 120, processor 130, signature matching engine 140 and memory devices 135 and 145. Port 120 is a representative port, and it should be understood that in exemplary embodiments, network device 110 includes multiple ports 120. Memory device 135 maintains a plurality of signatures 138. Memory device 145 maintains a set of signatures 148 that includes less than all of the signatures 138 in memory device 135.

For example, in one embodiment, one of more of the signatures 138/148 is a network intrusion detection signature that includes a pattern identifying a particular type of network attack. By way of example, but not limitation, network attacks may include viruses, worms, denial of service attacks, file access attacks, buffer overflow attempt attacks and other similar malicious activity. In this embodiment, the signatures 138/148 may range from simple signatures that identify illegal IP and TCP header values to complex signatures that track the state of a connection or perform extensive protocol analysis. In other embodiments, one or more of the signatures 138/148 may include a pattern that identifies unusual or suspicious traffic or policy violations (i.e., copyright infringement, undesirable usage patterns or other type of policy violation).

In accordance with various embodiments, the network device 110, together with the control server 160, are configured to implement a collaborative deep packet inspection mechanism. The collaborative deep packet inspection mechanism utilizes a combination of a coarse grain mechanism to analyze the network in conjunction with a fine grain mechanism to enforce corrective actions against threats, anomalies, or undesirable usage patterns. In an exemplary embodiment, the coarse grain mechanism and the fine grain mechanism are managed and coordinated by the control server 160 to ensure successful collaboration between the two. For example, the control server 160 may be utilized to collect the results of both mechanisms for the purposes of visualization and analysis. In addition, the control server 160 may further be operable to monitor, manage, and update both the coarse grain mechanism and the fine grain mechanism.

The coarse grain mechanism is performed by the control server 160, together with the processor 130. The processor 130 runs a long term analysis of the network traffic by performing deep packet inspection (DPI) on a portion of network traffic (sample packets 122) statistically sampled to the processor 130 using as large an amount of signatures 138 as feasible. As used herein, the term “deep packet inspection” refers to a form of computer network packet filtering that examines the body (data), and possibly, the header of a packet, with respect to the signatures 138 to identify any anomalies, threats, protocol non-compliance issues, policy violations or other undesirable traffic patterns. The long term analysis runs continuously in the background, building up an accurate profile 170 of the network, such as the various applications, usage patterns, etc, of the underlying network.

The processor 130 periodically or in response to a request provides the profile 170 to the control server 160. Based on the profile 170, the control server 160 derives a set of narrowly focused signatures 148 for use in real-time inspection of the network traffic and provides updates 180 accordingly to the set of signatures 148 maintained in memory device 145. The updates 180 may serve to add and/or remove signatures from the set of signatures 148. The updates 180 may be determined manually by a network operator and/or automatically using, for example, adaptive algorithms and/or neural networks on the control server 160. If there are new signatures that need to be added to the set of signatures 148, the control server 160 may build the new signatures and/or receive the new signatures from an external source.

The fine grain mechanism is performed by the signature matching engine 140. The signature matching engine 140 performs a real-time inspection of the network traffic 125, using the set of signatures 148. As indicated above, the set of signatures 148 represents a small fraction of the available signatures 138 utilized by the processor 130 in developing the profile 170. In an exemplary embodiment, the set of signatures 148 includes approximately 100 signatures (i.e., between 90 and 110 signatures). The real-time inspection runs concurrently and in parallel to the long term analysis, and can take corrective action in real-time on a flow by flow basis. Since the processor 130 builds and refines the profile 170 over time, the accuracy of the profile 170 actually improves over time. Thus, the signature set 148 used by the signature matching engine 130 can progressively become more relevant against the underlying network over time.

As used herein, the term “processor” is generally understood to be a device that is capable of driving a general-purpose computer, such as a PC. It is noted, however, that the processor 320 may include other processing devices, such as microcontrollers, Field Programmable Gate Arrays (FPGAs), multi-core processors or a combination thereof. In addition, as used herein, the term “memory device” refers to one or more a data storage device, random access memory (RAM), dynamic random access memory (DRAM), read only memory (ROM), flash memory, database or other type of storage device or storage medium.

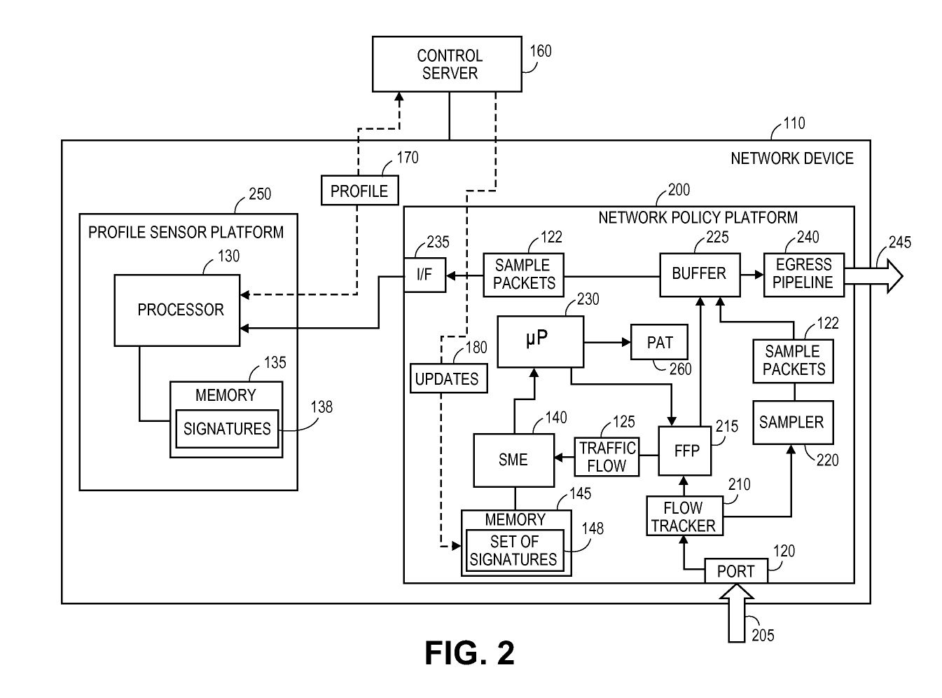

FIG. 2 illustrates another exemplary embodiment of a system for implementing collaborative deep packet inspection. In FIG. 2, the fine grain mechanism is implemented on a first platform (network policy platform 200) of the network device 110 and the coarse grain mechanism is implemented on a second platform (profile sensor platform 250) of the network device 110. The network policy platform 200 may be included within a switching platform in the network device 110 or on a separate platform from the switching platform. In an exemplary embodiment, each platform 100 and 250 corresponds to a separate die or integrated circuit within the network device 110.

The profile sensor platform 250 includes the processor 130 and memory device 135 maintaining the plurality of signatures 138. In an exemplary embodiment, the processor 130 may be included, for example, within a profile sensor, such as a Snort sensor that is capable of receiving and analyzing SFlow traffic (sample packets 122) against a plurality of Snort signatures 138. Since Snort is computationally and memory intensive, the rate of SFlow traffic 122 can be adjusted in order to not overwhelm the limited processing capacity of the profile sensor platform 250. In addition, since the Snort sensor is implemented using software, a sufficiently large number of Snort signatures 138 can be accommodated (only limited by the amount of memory 135, e.g., commodity DRAM). The sample packets 122 can be forwarded to the Snort sensor via an interface 235 (i.e., an internal SGMII interface) between the profile sensor platform 250 and the network policy platform 200.

The Snort sensor 130/135 performs deep packet inspection (DPI) on the sample packets 122 using the Snort signatures 138 and develops a profile 170 of the network based on the DPI. The Snort sensor 130/135 periodically or in response to a request provides the profile 170 to the control server 160. Based on the profile 170, the control server 160 identifies the set of signatures 148 for use by the network device 110 and provides updates 180 accordingly to the set of signatures 148 on the network policy platform 200. The updates 180 may serve to add and/or remove signatures from the set of signatures 148.

The network policy platform 200 includes the port 120, signature matching engine (SME) 140 and memory device 145 maintaining the set of signatures 138. As indicated above, the port 120 is merely a representative port and the network device 110 may include multiple ports. The port(s) receive incoming network traffic 205 from the network. The network traffic typically includes a plurality of traffic flows, each including a plurality of packets.

The network policy platform 200 further includes a flow tracker 210, fast filter processor (FFP) 215, sampler 220, buffer 225, microprocessor 230 and egress pipeline 240. The flow tracker 210 receives the incoming network traffic 205 from the port(s) 120 and performs basic 5 tuple classification in order to identify each IP flow, forming, for example, the following set: {Source IPv4/IPv6 Address, Destination IPv4/IPv6 Address, Source Port #, Destination Port #, TCP or UDP}. Each set uniquely identifies an IP flow. In the case of TCP flows, the flow tracker 210 can also track their TCP states. In addition, the flow tracker 210 can further maintain a timer for each traffic flow and periodically renew or retire a traffic flow based on their activity level. For example, the flow tracker 210 can retire a traffic flow at the expiration of the timer or can restart the timer (renew the traffic flow) upon receiving a new packet for that traffic flow.

The flow tracker 210 copies the incoming network traffic to the sampler 220, which implements a sampling algorithm to select sample packets 122 from the network traffic to forward to the profile sensor platform 250. The sampling algorithm may be a random sampling algorithm or other type of sampling algorithm. In an exemplary embodiment, the sampler 220 is an SFlow sampler. The sample packets 122 are provided to the buffer 225, and forwarded to the profile sensor platform 250 via interface 235.

The flow tracker 210 further identifies new traffic flows and forwards traffic flows to the FFP 215 for processing. Once a new traffic flow 125 has been identified, its associated traffic is copied from the FFP 215 to the SME 140 in real-time for inspection using the set of signatures 148 in memory device 145. The SME 140 and memory device 145 may be implemented using, for example, a dedicated hardware engine that can track TCP/IP flow states, perform signature matching using a regular expression (REGEX) processor, and automatically make network policy decisions based on a combination of purpose-built hardware and embedded software.

In an exemplary embodiment, the SME 140 performs a REGEX pattern match of the traffic flow 125 against the set of signatures 148, which may be, for example, encoded in a Snort compatible Perl compatible REGEX (PCRE) format. Due to the complexity of REGEX automata, the SME 140 can only accommodate a small number of signatures, i.e., approximately 100 signatures. Therefore, the set of signatures is updated periodically, as described above, thus ensuring that the set of signatures includes the most relevant signatures for the network.

The SME 140 compares the traffic flow 125 against every signature in the set of signatures 148. If a match is identified, the SME 140 notifies the microprocessor 230 and furnishes to the microprocessor 230 an identification tag of the matched signature, the associated traffic flow, and a list of policy actions recommended for application against the matched signature. The policy action(s) may include, for example, redirecting packets in the traffic flow, marking packets in the traffic flow, blocking packets in the traffic flow and reporting the traffic flow to a reporting device, such as the control server 160, within the network.

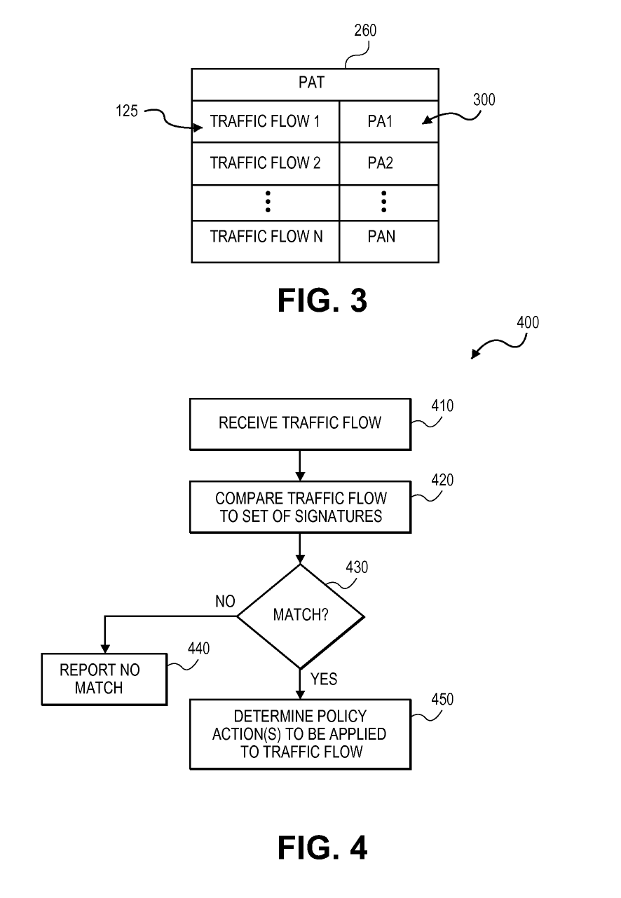

The microprocessor 230 maintains a policy action table 260. Once notified of a signature match, the microprocessor 230 analyzes the recommended list of policy actions with respect to the associated traffic flow, and takes corrective action by installing the appropriate policy action(s) into the policy action table 260 for that traffic flow. An example of a policy action table 260 maintaining policy actions 300 and traffic flows 125 is shown in FIG. 3. Since policy actions are installed on a flow by flow basis, the installed policy action(s) do not affect other traffic flows.

Referring again to FIG. 2, the microprocessor 230 further notifies the FFP 215 of the installed policy action(s) for the traffic flow 125, so that the FFP 215 can take the appropriate action with respect to the traffic flow, such as marking packets in the flow, blocking packets in the flow, redirecting packets in the flow and reporting the traffic flow. Any flows that are not blocked may be provided to the buffer 225, which can then provide the packets in the outgoing traffic flows to the egress pipeline 240 for further processing of the outgoing traffic flows 245.

FIG. 4 illustrates an exemplary flow diagram of a method 400 for real-time inspection of a traffic flow by the Signature Matching Engine (SME). The method begins at 410, where a traffic flow is received by the SME. At 420, the SME compares the traffic flow to a small set of signatures. The set of signatures is continually updated, as needed, to include those signatures most relevant to the network. At 430, a determination is made whether the traffic flow matches one or more of the signatures. If not, at 440, the SME reports to the microprocessor that the traffic flow does not match any of the signatures and the traffic flow is handled normally for processing. If the traffic flow does match one or more of the signatures, at 450, the SME determines the policy action(s) recommended to be applied to the traffic flow and provides to the microprocessor an identification tag of the matched signature(s), the associated traffic flow, and the policy action(s) recommended for application against the matched signature.

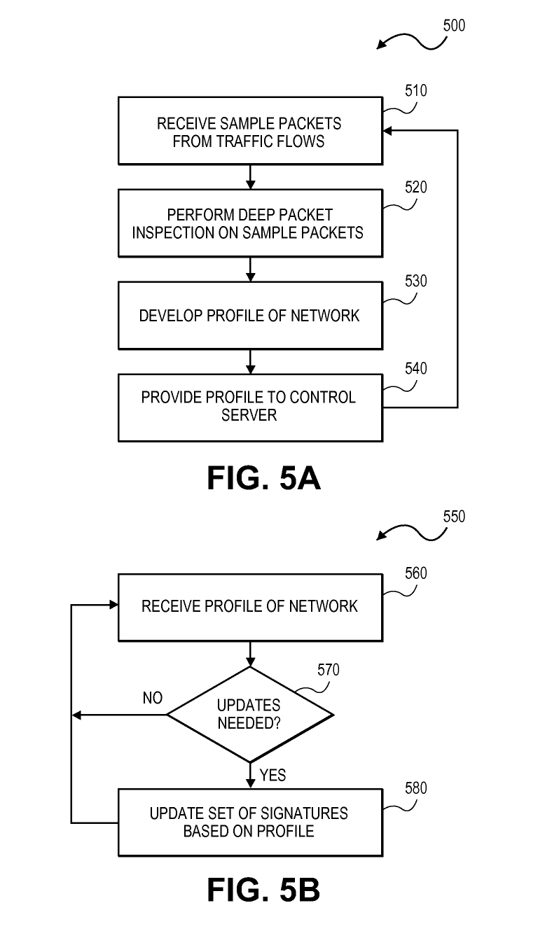

FIG. 5A illustrates an exemplary flow diagram of a method 500 for performing deep packet inspection on sample packets by the Snort sensor. The method begins at 510, where sample packets from traffic flows received at a network device are copied to the profile sensor (i.e., Snort sensor). At 520, the profile sensor performs deep packet inspection on the sample packets, and at 530, develops a profile of the network based on the deep packet inspection. At 540, the profile sensor provides the profile to a control server in the network for further processing and handling. The method repeats at 510 with new sample packets being received by the profile sensor.

FIG. 5B illustrates an exemplary flow diagram of a method 550 for updating a set of signatures used for real-time inspection of a traffic flow by a control server. The method begins at 560, where the control server receives an updated profile of the network from the profile sensor. At 570, the control server determines whether updates to the set of signatures in the network device are needed based on the profile. For example, the control server can use the profile to identify a new set of signatures and compare the new set of signatures to the current set of signatures maintained by the network device to determine whether any differences exist, and if so, determine that updates are needed. If updates are needed, at 580, the control server updates the set of signatures in the network device by adding and/or removing signatures in the set of signatures. The process repeats at 560 with a new profile being received by the control server.

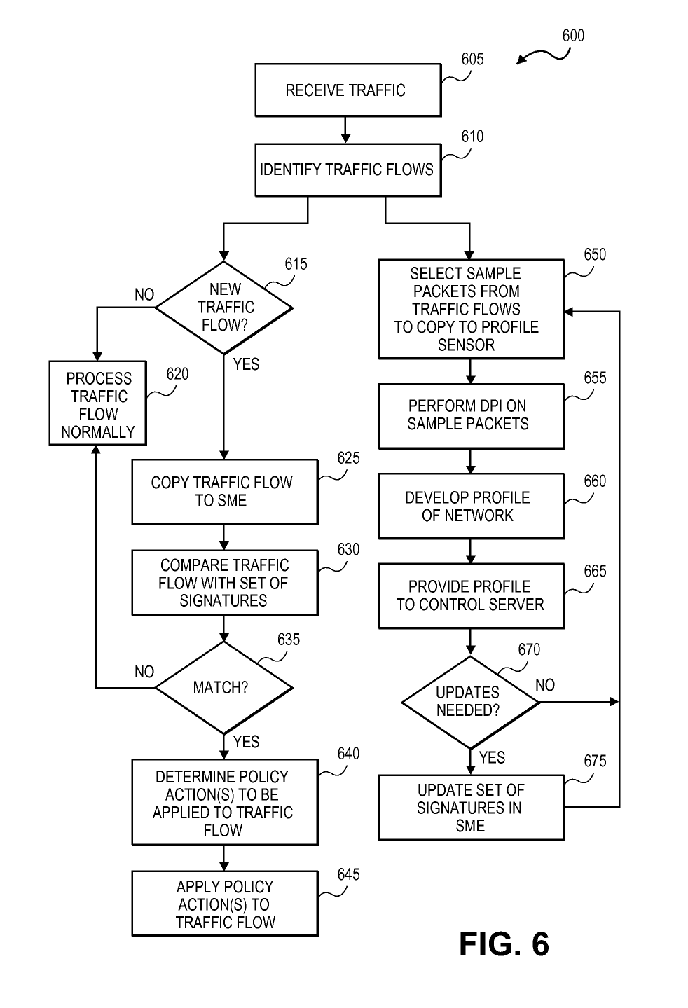

FIG. 6 illustrates an exemplary flow diagram of a method 600 for collaborative deep packet inspection. The method begins at 605, where a network device receives a plurality of traffic flows, each including a plurality of packets. At 610, the traffic flows are identified, and at 615, a determination is made whether there is a new traffic flow. If not, the traffic flows are handled normally or as indicated in the policy action table. If there is a new traffic flow, at 625, the traffic flow is copied to the Signature Matching Engine (SME) in the network device for real-time inspection of the traffic flow. At 630, the SME compares the traffic flow with the set of signatures in the network device, and at 635, determines whether the traffic flow matches any of the signatures. If not, the method returns to 620 to process the traffic flow normally.

If the traffic flow does match one or more of the signatures, the SME determines the policy action(s) recommended to be applied to the traffic flow and provides to the microprocessor in the network device an identification tag of the matched signature(s), the associated traffic flow, and the policy action(s) recommended for application against the matched signature(s). At 645, the microprocessor analyzes the recommended list of policy actions with respect to the associated traffic flow, and takes corrective action by installing the appropriate policy action(s) into the policy action table for that traffic flow.

Concurrently to the real-time inspection process illustrated in 615-640, once the traffic flows are identified at 610, the method also proceeds to 650, where sample packets are selected from the traffic flows and copied to the profile sensor (i.e., Snort sensor). At 655, the profile sensor performs deep packet inspection on the sample packets using as large a number of signatures as possible. At 660, the profile sensor develops a profile of the network based on the deep packet inspection, and at 665, provides the profile to the control server. At 670, the control server determines whether any updates are needed to the set of signatures used by the SME for real-time inspection based on the profile. If not, the process repeats at 650 with the profile sensor receiving new sample packets for deep packet inspection. If the control sever determines that updates to the set of signatures are needed, at 675, the control server updates the set of signatures.

As may be used herein, the term “operable to” indicates that an item includes one or more of processing modules, data, input(s), output(s), etc., to perform one or more of the described or necessary corresponding functions and may further include inferred coupling to one or more other items to perform the described or necessary corresponding functions. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal. As may still further be used herein, inferred coupling (i.e., where one element is coupled to another element by inference) includes direct and indirect coupling between two items in the same manner as “coupled to”.

Embodiments have also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Similarly, flow diagram blocks may also have been arbitrarily defined herein to illustrate certain significant functionality. To the extent used, the flow diagram block boundaries and sequence could have been defined otherwise and still perform the certain significant functionality. One of average skill in the art will also recognize that the functional building blocks, and other illustrative blocks, modules and components herein, can be implemented as illustrated or by one or multiple discrete components, networks, systems, databases or processing modules executing appropriate software and the like or any combination thereof.

What is claimed is:

1. A network device, comprising:
at least one port coupled to a network to receive a plurality of traffic flows, each including a plurality of packets;
a memory maintaining a set of signatures;
a processor for receiving sample packets sampled from the plurality of traffic flows and performing deep packet inspection on the sample packets against a plurality of signatures to develop a profile of the network, the profile indicating network activity within the network, the processor further for enabling the set of signatures to be updated based on the profile, the set of signatures including less than all of the plurality of signatures; and
a signature matching engine for receiving a traffic flow of the plurality of traffic flows and inspecting the traffic flow in real-time by comparing the traffic flow with each signature in the set of signatures, the signature matching engine further for determining whether the traffic flow matches one of the signatures in the set of signatures and enabling at least one policy action to be applied to the traffic flow when the traffic flow matches one of the signatures in the set of signatures.

2. The network device of claim 1, wherein the profile includes at least one of applications running on the network and usage patterns in the network.

3. The network device of claim 1, wherein the set of signatures is updated by at least one of adding one or more signatures from the plurality of signatures to the set of signatures and removing one or more signatures from the set of signatures.

4. The network device of claim 1, wherein the sample packets are sampled randomly from the plurality of packets and include less than all of the plurality of packets.

5. The network device of claim 4, wherein the sample packets are copies of select ones of the plurality of packets.

6. The network device of claim 1, further comprising:
a first platform including the processor;
a second platform including the signature matching engine and the memory; and
an internal interface between the first platform and the second platform, the sampled packets being forwarded to the processor via the internal interface.

7. The network device of claim 6, further comprising:
a microprocessor on the second platform coupled to the signature matching engine to enforce the at least one policy action to be applied to the traffic flow.

8. The network device of claim 7, wherein the signature matching engine further:
determines flow identification information identifying the traffic flow;
determines an identification tag of a matching signature in the set of signatures that matches the traffic flow;
determines a list of policy actions including the at least one policy action recommended for the matching signature; and
sends the identification tag, the flow identification information and the list of policy actions to the microprocessor.

9. The network device of claim 8, wherein the microprocessor selects the at least one policy action from the list of policy actions to be applied to the traffic flow.

10. The network device of claim 9, further comprising:
a policy action table maintained by the microprocessor, the microprocessor updating the policy action table with the flow identification information and the at least one policy action.

11. The network device of claim 8, wherein the flow identification information includes at least a source Internet Protocol (IP) address, a destination IP address, a source port number and a destination port number.

12. The network device of claim 1, wherein the at least one policy action includes one or more of redirecting packets in the traffic flow, marking packets in the traffic flow, blocking packets in the traffic flow and reporting the traffic flow to a reporting device within the network.

13. The network device of claim 1, wherein the set of signatures includes approximately 100 signatures.

14. A system for collaborative deep packet inspection in a network, comprising:
a network device, the network device including:
at least one port coupled to the network to receive a plurality of traffic flows, each including a plurality of packets;
a memory maintaining a set of signatures;
a processor for receiving sample packets sampled from the plurality of traffic flows and performing deep packet inspection on the sample packets against a plurality of signatures to develop a profile of the network, the profile indicating network activity within the network; and
a signature matching engine for receiving a traffic flow of the plurality of traffic flows and inspecting the traffic flow in real-time by comparing the traffic flow with each signature in the set of signatures, the signature matching engine further for determining whether the traffic flow matches one of the signatures in the set of signatures and enabling at least one policy action to be applied to the traffic flow when the traffic flow matches one of the signatures in the set of signatures; and
a control server coupled to the network to receive the profile from the network device and update the set of signatures in the network device based on the profile, the set of signatures including less than all of the plurality of signatures.

15. The system of claim 14, wherein the network device further includes:
a policy action table including flow identification information identifying the traffic flow and the at least one policy action applied to the traffic flow, wherein the control server further monitors the policy action table.

16. The system of claim 14, wherein the network device is a switch or a router in the network.

17. The system of claim 14, wherein the control server updates the set of signatures by at least one of adding one or more signatures from the plurality of signatures to the set of signatures and removing one or more signatures from the set of signatures.

18. A method for collaborative deep packet inspection in a network device, comprising:
maintaining a set of signatures;
receiving a plurality of traffic flows, each including a plurality of packets;
sampling sample packets from the plurality of traffic flows;
performing deep packet inspection on the sample packets against a plurality of signatures to develop a profile of the network, the profile indicating network activity within the network;
updating the set of signatures based on the profile, the set of signatures including less than all of the plurality of signatures;
inspecting a traffic flow of the plurality of traffic flows in real-time by comparing the traffic flow with each signature in the set of signatures;
determining whether the traffic flow matches one of the signatures in the set of signatures; and
applying at least one policy action to the traffic flow when the traffic flow matches one of the signatures in the set of signatures.

19. The method of claim 18, wherein the sampling the sample packets, the performing the deep packet inspection and the updating the set of signatures are performed in parallel to the inspecting the traffic flow and the applying the at least one policy action.

20. The method of claim 18, wherein the applying the at least one policy action further includes:
updating a policy action table with flow identification information identifying the traffic flow and the at least one policy action applied to the traffic flow.
